(19) United States
(12) Patent Application Publication
(10) Pub. No.: US 2009/0113035 A1
(43) Pub. Date: Apr. 30, 2009

(54) NETWORK MANAGEMENT APPARATUS AND METHOD

(75) Inventor: Toshio Ohashi, Chigasaki-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/259,598

(22) Filed: Oct. 28, 2008

(30) Foreign Application Priority Data
Oct. 30, 2007 (JP) 2007-281835

(51) Int. Cl. G06F 15/173

(52) U.S. Cl. 709/223

(57) ABSTRACT

A method for a network management apparatus configured to communicate with a peripheral device using a version of Simple Network Management Protocol (SNMP) that requires key information during communication includes acquiring device-specific information from the peripheral device, generating a plurality of key information candidates using the device-specific information before performing a communication based on SNMP, acquiring an SNMP engine identification (ID) for the peripheral device, determining whether the SNMP engine ID corresponds to the device-specific information, and, if it is determined that the SNMP engine ID corresponds to the device-specific information, storing the SNMP engine ID and performing a communication based on SNMP using key information corresponding to the device-specific information and selected from among the plurality of key information candidates.

### BACKGROUND OF THE INVENTION

1. Field of the Invention

The present invention relates to a method and apparatus for managing a network device, more specifically, a method and apparatus to manage a network device to perform short and secure data communication.

2. Description of the Related Art

In recent years, as a network management protocol, Simple Network Management Protocol (SNMP) has attracted much attention and been widely used.

SNMP includes two versions, namely, SNMP Version 1 (SNMPv1) and SNMP Version 3 (SNMPv3), for example. In particular, SNMPv3 includes an intensified security function, such as an authentication function or an encryption function, which is executed during data communication. Meanwhile, in recent years, the market has desired a high security in data communication. In this regard, more and more network devices, such as a network printer and utility software that manages the network device, have complied with SNMPv3.

In SNMPv3, authentication processing and encrypted communication are performed by an SNMP engine between a data sending apparatus and a data receiving apparatus. The SNMP engine is identified with an identifier such as a unique SNMP engine identification (ID). The SNMP engine performs authentication and encryption on an SNMP message and sends and receives the authenticated SNMP message to and from an apparatus on a network.

With respect to a specification for authentication and encryption according to SNMPv3, a user-based security model defined by the Request for Comments (RFC) 3414 (SNMPv3USM) is generally used.

In SNMPv3USM, an SNMP engine ID acquires an SNMP engine ID from a peripheral device before sending a message. Then, a private key for authentication and encryption is generated using the acquired SNMP engine ID and a password. Then, authentication processing and an encrypted communication are performed.

However, with respect to an authenticated and encrypted communication including a communication performed based on SNMPv3, such a problem may arise that the time taken for the communication may become long if a parameter is acquired at every occasion of communication to generate a key for authentication and encryption.

In this regard, each of Japanese Patent Application Laid-Open No. 2000-278258 and Japanese Patent Application Laid-Open No. 2005-085090 discusses a method in which a key and a parameter acquired at the first communication are cached and the cached key and a parameter are utilized in a subsequent communication instead of generating a key by acquiring a parameter at every communication.

The method discussed in each of Japanese Patent Application Laid-Open No. 2000-278258 and Japanese Patent Application Laid-Open No. 2005-085090 is useful in the case where neither a key nor a parameter is changed regardless of a timing of acquisition and generation thereof. Accordingly, with such a conventional method, the time taken for the communication can be shortened while keeping a high network data security.

### SUMMARY OF THE INVENTION

An embodiment of the present invention is directed to a network management apparatus and a network management method configured to effectively manage a network device to effectively perform a data communication in a relatively short length of time with a high level of data security.

According to an aspect of the present invention, a method for a network management apparatus configured to communicate with a peripheral device using a version of Simple Network Management Protocol (SNMP) that requires key information during communication includes acquiring device-specific information from the peripheral device, generating a plurality of key information candidates using the device-specific information before performing a communication based on SNMP, acquiring an SNMP engine identification (ID) for the peripheral device, determining whether the SNMP engine ID corresponds to the device-specific information, and, if it is determined that the SNMP engine ID corresponds to the device-specific information, storing the SNMP engine ID and performing a communication based on SNMP using key information corresponding to the device-specific information and selected from among the plurality of key information candidates.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the present invention.

FIG. 1 illustrates an example of a configuration of a network management system according to an exemplary embodiment of the present invention.

FIG. 2 illustrates an example of a hardware configuration of a computer illustrated in FIG. 1 according to an exemplary embodiment of the present invention.

FIG. 3 illustrates an example of a software configuration of the computer illustrated in FIG. 1 according to an exemplary embodiment of the present invention.

FIG. 4 illustrates an example of a hardware configuration of an image processing apparatus illustrated in FIG. 1 according to an exemplary embodiment of the present invention.

FIG. 5 illustrates an example of a software configuration of the image processing apparatus according to an exemplary embodiment of the present invention.

FIG. 6 illustrates an example of an authentication information input screen according to an exemplary embodiment of the present invention.

FIG. 7 is a flow chart that illustrates an example of processing for registering authentication information according to an exemplary embodiment of the present invention.

FIG. 8 illustrates an example of a key generation method according to an exemplary embodiment of the present invention.

FIG. 9 is a flow chart that illustrates an example of processing for changing a setting for the image processing apparatus according to an exemplary embodiment of the present invention.

FIG. 10 illustrates an example of a setting item input screen according to an exemplary embodiment of the present invention.

FIG. 11 is a flow chart that illustrates a detailed example of processing for changing a setting for the image processing apparatus according to an exemplary embodiment of the present invention.

FIG. 12 is a flow chart that illustrates a detailed example of a processing for changing a setting for the image processing apparatus according to an exemplary embodiment of the present invention.

FIG. 13 is a flow chart that illustrates an example of processing for registering authentication information according to an exemplary embodiment of the present invention.

FIG. 14 is a flow chart that illustrates a detailed example of processing for changing a setting for the image processing apparatus according to an exemplary embodiment of the present invention.

FIG. 15 is a flow chart that illustrates an example of search processing according to an exemplary embodiment of the present invention.

FIG. 16 is a flow chart that illustrates a detailed example of processing for changing a setting for the image processing apparatus according to an exemplary embodiment of the present invention.

FIG. 17 illustrates an SNMP engine ID type classification table.

### DETAILED DESCRIPTION OF THE EMBODIMENTS

Various exemplary embodiments, features, and aspects of the present invention will now be herein described in detail below with reference to the drawings. It is to be noted that the relative arrangement of the components, the numerical expressions, and numerical values set forth in these embodiments are not intended to limit the scope of the present invention.

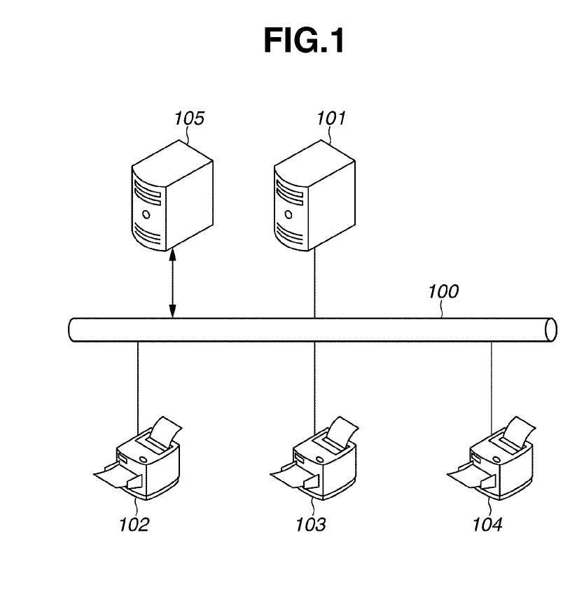

FIG. 1 illustrates an exemplary configuration of a network management system according to a first exemplary embodiment of the present invention. Referring to FIG. 1, the network management system includes a computer 101 and an image processing apparatus 102. The computer 101 and the image processing apparatus 102 are connected to each other via a network 100. Here, two or more network management apparatuses can be provided in the system.

With respect to the network 100, a network can be used in which a Transmission Control Protocol/Internet Protocol (TCP/IP) network can be structured and an SNMP protocol for monitoring and controlling a communication device via the network can be utilized. More specifically, a local area network (LAN), for example, can be used as the network 100.

In the following description, a hardware configuration and a software configuration of each of the computer 101 and the image processing apparatus 102 are respectively described. The image processing apparatus 102 performs image processing. A printer, a facsimile, a scanner, or a multifunction peripheral (MFP) including functions of these devices can be used as the image processing apparatus 102. In the example illustrated in FIG. 1, the image processing apparatus 102 is a printer.

The image processing apparatus 102 is an example of a network device. A client computer 105 communicates with a management utility 303 of the computer 101 to display various information using a web browser.

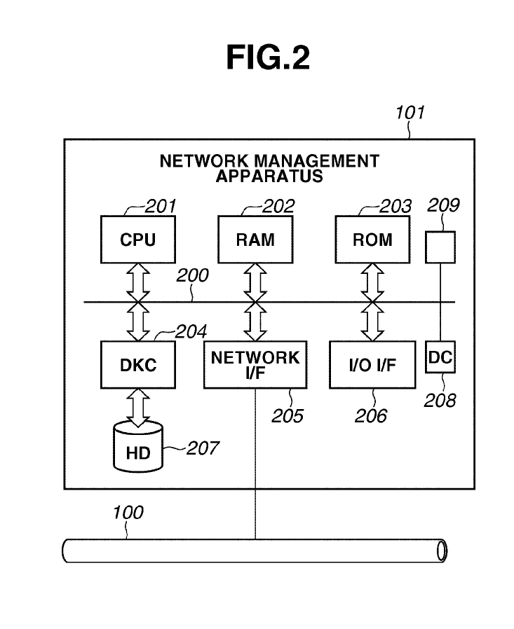

FIG. 2 illustrates an example of a hardware configuration of the computer 101 according to the present exemplary embodiment. Referring to FIG. 2, an input device/pointing device control unit 209 controls an input device, such as a keyboard, and a pointing device, such as a mouse. A display controller (DC) 208 controls a display, which is an example of a display unit.

The computer 101 is constituted by a general-purpose computer. A system bus 200 functions to connect each component of the computer 101.

A central processing unit (CPU) 201 performs control of the entire computer 101 and calculation processing. A random access memory (RAM) 202 is an area on which various programs and various data are loaded and executed as necessary for various processing.

A read-only memory (ROM) 203 is a storage area for storing a system boot program. A disk controller (DKC) (external storage device control unit) 204 controls an external storage device such as a hard disk (HD) 207. The HD 207 stores a program and data. The CPU 201 loads and executes the program and data from the HD 207 on the RAM 202 during processing.

The computer 101 operates after the CPU 201 has executed a basic input and output (I/O) program and an operating system (OS). The basic I/O program is written on the ROM 203. The OS is written on the HDD 207.

When the computer 101 is powered on, the OS is loaded from the HD 207 on the RAM 202 by an initial program loading function in the basic I/O program to start the OS.

A network interface (I/F) 205 is connected to the network 100 and performs a network communication. An I/O I/F 206 is connected to an input device, such as a keyboard, and a pointing device, such as a mouse, to input and output data. The client computer 105 basically has a configuration similar to that of the computer 101.

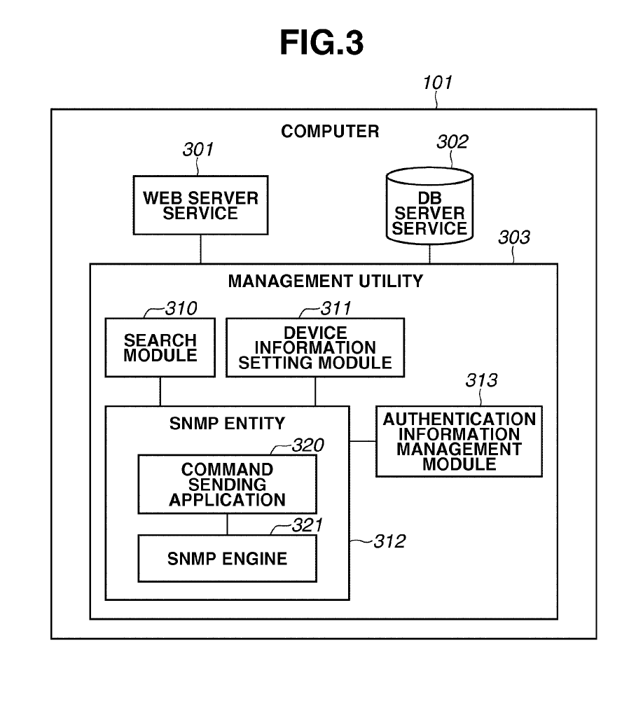

FIG. 3 illustrates an example of a software configuration of the computer 101, which is an example of a network management apparatus. Here, the present exemplary embodiment is described on such a premise that a basic I/O program and an OS of the computer 101 have been already started.

The computer 101 includes a web server service 301, a database (DB) server service 302, and a management utility 303. The software is written on the HD 207 in FIG. 2 as a program.

The CPU 201 (FIG. 2) loads and executes each of software 301, 302, 303, 310, 311, 313, and 312 illustrated in FIG. 3 from the HD 207 on the RAM 202.

The web server service 301 provides a service for sending web page data stored on the HD 207 when a GET request based on Hypertext Transport Protocol (HTTP) is received from the web browser of the client computer 105.

An external apparatus can be connected with the computer 101 via the network 100 by using the web server service 301. Note that in the case where it is not necessary to connect an external apparatus to the management utility 303 of the computer 101, it is unnecessary to provide the web browser service 301.

The DB server service 302 provides a service for storing data to be utilized by the management utility 303 and acquiring the stored data. The DB server service 302 can be provided on a computer connected via the network 100 other than the computer 101 instead of providing it in the computer 101. In the case where the management utility 303 separately and independently acquires and stores data, the DB server service 302 is dispensable.

The management utility 303 performs data communication with the image processing apparatus 102, which is connected with the management utility 303 via the network 100. A web browser can be used as a user interface of the management utility 303.

The management utility 303 is software for changing the setting for the image processing apparatus 102 and monitoring a status of the image processing apparatus 102. The management utility 303 can monitor the image processing apparatus 102 at predetermined time intervals.

The management utility 303 includes function modules, such as a searching module 310, a device information setting module 311, and an authentication information management module 313, and an SNMP entity 312. Note that in the present exemplary embodiment, the device information setting module 311 is used as an example of a module for performing an SNMPv3 communication. However, a module having a function for performing an SNMP communication different from a device information setting function can be used instead.

The searching module 310 has the function for searching for an image processing apparatus that is connected to the network 100. The device information setting module 311 has a function for changing setting information for the image processing apparatus 102, which is connected to the network 100 and has been searched for and extracted as a result of the search, via the network 100.

In the case of an SNMPv3 communication with a plurality of image processing apparatuses 102, 103, and 104 (FIG. 1), authentication information stored by the authentication information management module 313 is used to perform the communication. The authentication information management module 313 has a function for storing an SNMPv3 password entered by a user for the image processing apparatus that is connected to the network 100 and has been searched for and extracted as a result of the search.

The SNMP entity 312 is constituted by a command sending application 320 and an SNMP engine 321. The SNMP entity 312 implements a management function using SNMP. The command sending application 320 has a function for acquiring and setting management information for a network device including the image processing apparatus 102.

The SNMP engine 321 is identified with a unique SNMP engine ID. The SNMP engine 321 performs authentication and encryption of an SNMP message and sends and receives the authenticated and encrypted SNMP message via the network 100. The client computer 105 can have a similar configuration as that described above. Furthermore, it is also useful if the client computer 105 includes a function as the web browser only.

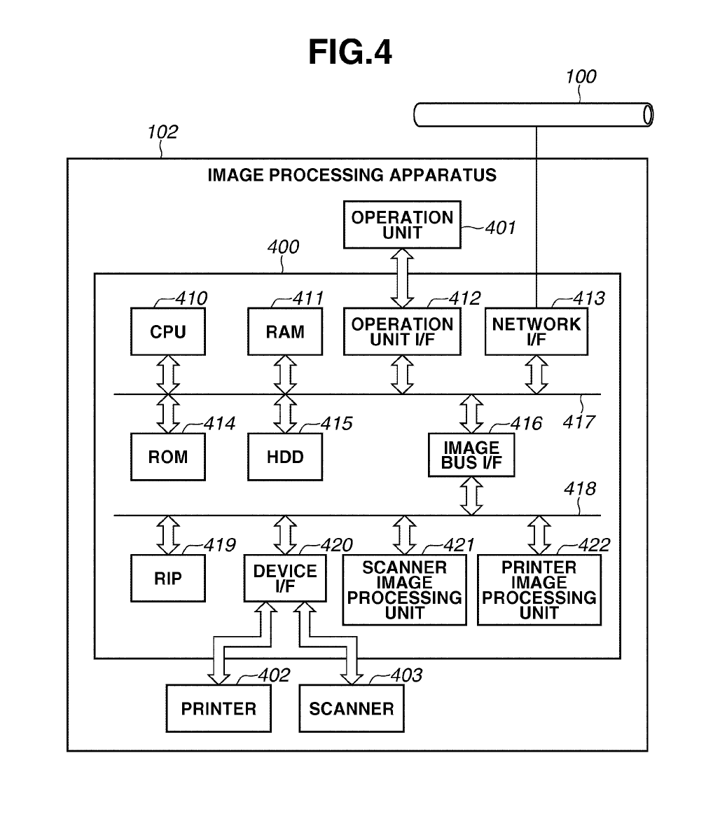

FIG. 4 illustrates an example of a hardware configuration of a multifunction peripheral (MFP) (multifunctional printer), which is an example of the image processing apparatus 102 according to the present exemplary embodiment. As described above, the image processing apparatus 102 can include a device or an apparatus other than the MFP (a single-function printer, a facsimile machine, etc.)

The image processing apparatus 102 includes an operation unit 401, a printer 402, a scanner 403, and a control unit 400. The control unit 400 is connected to the network 100 and performs control for performing a communication with the computer 101.

The operation unit 401, the printer 402, and the scanner 403 are connected to the control unit 400. Thus, the control unit 400 can control the operation of the operation unit 401, the printer 402, and the scanner 403. Note that a plurality of image processing apparatuses can include no scanner.

The control unit 400 includes a CPU 410, a RAM 411, an operation unit I/F 412, a network I/F 413, a ROM 414, an HDD 415, an image bus I/F 416, a system bus 417, an image bus 418, a raster image processor (RIP) 419, a device I/F 420, a scanner image processing unit 421, and a printer image processing unit 422. With respect to the above-described components of the image processing apparatus 102, the scanner 403 and the scanner image processing unit 421 are not always necessary.

The CPU 410 is a controller that controls the operation of the entire control unit 400. The RAM 411 is a system work memory used by the CPU 410 to perform an operation. Furthermore, the RAM 411 is an image memory that temporarily stores image data.

The operation unit I/F 412 is an interface with the operation unit 401. The operation unit I/F 412 outputs, to the operation unit 401, image data to be displayed on a screen of the operation unit 401. Furthermore, the operation unit I/F 412 sends information input by a user via the operation unit 401 to the CPU 410. The network I/F 413 is an interface with the network 100. Thus, information is input and output to and from the network 100 via the network I/F 413.

The ROM 414 is a boot ROM that stores a system boot program. The HDD 415 stores system software and image data.

The image bus I/F 416 is an interface between the system bus 417 and the image bus 418. More specifically, the image bus I/F 416 is a bus bridge for converting a data structure. The image bus 418 is constituted by a peripheral component interconnect (PCI) bus or an Institute of Electrical and Electronic Engineers (IEEE) 1394 bus.

The RIP 419 rasterizes a page description language (PDL) command sent from the network 100 into a bitmap image. The device I/F unit 420 is an interface between the image input and output devices, such as the printer 402 or the scanner 403, and the control unit 400. The device I/F unit 420 performs a synchronous/asynchronous conversion on image data.

The scanner image processing unit 421 performs correction, image processing, and editing on input image data. The printer image processing unit 422 performs correction processing and resolution conversion processing on print output image data according to the performance of the printer 402.

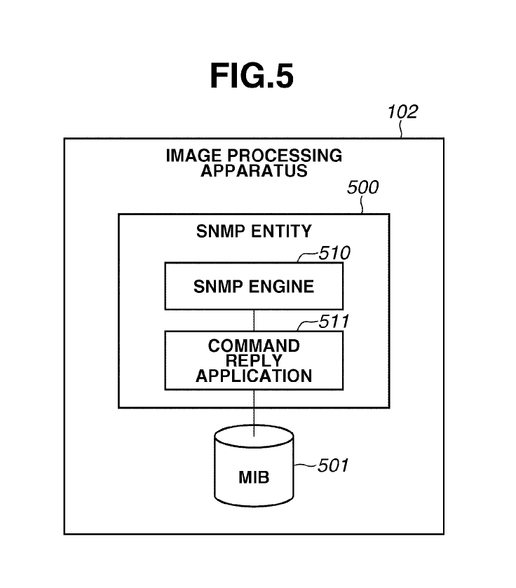

FIG. 5 illustrates an example of a software configuration of the image processing apparatus 102 according to the present exemplary embodiment. The image processing apparatus 102 includes an SNMP entity 500 and a management information base (MIB) object 501. The software is stored on the HDD 415 as a program. Furthermore, the CPU 410 loads and executes the software on the RAM 411.

Referring to FIG. 5, the SNMP entity 500 includes an SNMP engine 510 and a command reply application 511. The SNMP entity 500 implements a management function using SNMP. The SNMP engine 510 is identified with a unique SNMP engine ID. The SNMP engine 510 performs authentication and encryption of an SNMP message and sends and receives the authenticated and encrypted SNMP message via the network 100.

When a management information acquisition request command or a setting request command is received from the computer 101, the command reply application 511 accesses the MIB object 501. The command reply application 511 has a function for sending the accessed MIB object to the computer 101 as a reply to the received request command.

The MIB object 501 defines management information for the image processing apparatus, which is basically defined by Structure of Management Information (SMI). Various information, such as printer status information, error information, printer identifier information, job information, or configuration information about a paper feed or discharge tray, for example, can be defined as an object. Here, it is also useful to implement an SNMP entity in the network I/F 413.

Now, an operation of the computer 101 is described below. The operation of the computer 101 primarily includes searching for an image processing apparatus, registration of authentication information, and changing of a setting for the image processing apparatus.

With respect to the operation for searching for an image processing apparatus, the management utility 303 of the computer 101 searches for the image processing apparatus 102 on the network 100 by utilizing the searching module 310. Here, the searching module 310 sends a command for acquiring an Internet Protocol (IP) address and a Media Access Control (MAC) address of the image processing apparatus 102 using a broadcast address based on an arbitrarily designated protocol.

Any protocol can be used as the protocol with which the IP address and the MAC address of the image processing apparatus to be managed can be acquired. More specifically, SNMPv1, SNMPv3, or Service Location Protocol (SLP), for example, can be used.

In this regard, in the case of using SNMPv3, the searching module 310 uses the command sending application 320 of the SNMP entity 312 to broadcast-send a command for acquiring an SNMP engine ID. Then, the command sending application 320 sends a packet at a security level of no authentication or encryption thereof (noAuthnoPriv) using the SNMP engine 321.

The SNMP engine 510 of the image processing apparatus receives a packet requesting sending an SNMP engine ID. Then, the SNMP engine 510 sends an SNMP engine ID as a reply to the packet.

When the SNMP engine 321 of the computer 101 receives the reply (the SNMP engine ID), the image processing apparatus 102, which is a sending source of the reply, is recognized as a management target device on the network 100. Then, the computer 101 sends a command for acquiring a MAC address based on an arbitrary protocol to the management target image processing apparatus 102 to acquire the MAC address.

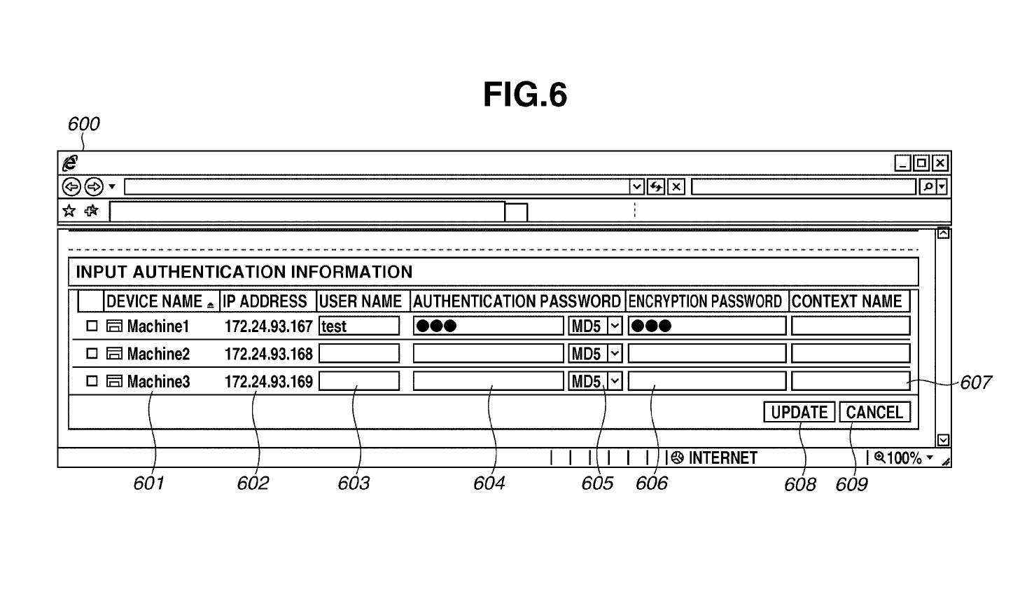

With respect to an SNMPv3-compliant image processing apparatus among the image processing apparatuses which have been recognized as target apparatuses of the management by the computer 101, authentication information therefor is required to perform data communication. Here, the user enters the authentication information via an authentication information registration screen illustrated in FIG. 6.

More specifically, the authentication information registration screen of the management utility 303 (FIG. 6) is displayed on a display of the client computer 105. Thus, the computer 101 acquires the authentication information entered by the user by operating a keyboard or a mouse of the client computer 105.

FIG. 6 illustrates an example of the authentication information input screen to be displayed on the display of the client computer 105 when the user has accessed the management utility 303 of the computer 101 by operating the client computer 105 via a web browser according to the present exemplary embodiment.

In the example illustrated in FIG. 6, SNMPv3-compliant image processing apparatuses are displayed as a list. The user can enter the authentication information for each image processing apparatus and register the authentication information to the computer 101.

Here, a web browser UI 600 is displayed on the authentication information registration screen. The authentication information registration screen includes SNMPv3-compliant image processing apparatus names 601. The SNMPv3-compliant image processing apparatus names 601 correspond to the image processing apparatuses 102 through 104 (FIG. 1), respectively.

Furthermore, the authentication information registration screen includes an IP address 602 of the SNMPv3-compliant image processing apparatus. In addition, the authentication information registration screen includes a user name entry field 603 for entering the name of the user, which is the authentication information for SNMPv3. Furthermore, the authentication information registration screen includes an authentication password entry field 604 for entering an authentication password, which is authentication information for SNMPv3, a hash algorithm entry field 605 for entering a hash algorithm used for authentication, an encryption password entry field 606, and a context name entry field 607.

When the user presses an update button 608, the authentication information entered in each field is sent to the computer 101 from the client computer 105. Then, the computer 101 stores the authentication information in the DB server service 302.

When the user presses a cancel button 609, the client computer 105 cancels processing for registering the authentication information. With respect to the parameter for the authentication information, it is not always necessary to cause the user to enter information in all of the fields 603 through 607

The parameters can be customized as necessary. That is, for example, with respect to a context name, a system fixed value can be used without causing the user to enter a context name.

Furthermore, it is also useful if the same authentication information is registered in all the image processing apparatuses managed by the computer 101 and the registered authentication information is sent from the client computer 105 to the computer 101, instead of managing the authentication information for each image processing apparatus as described above.

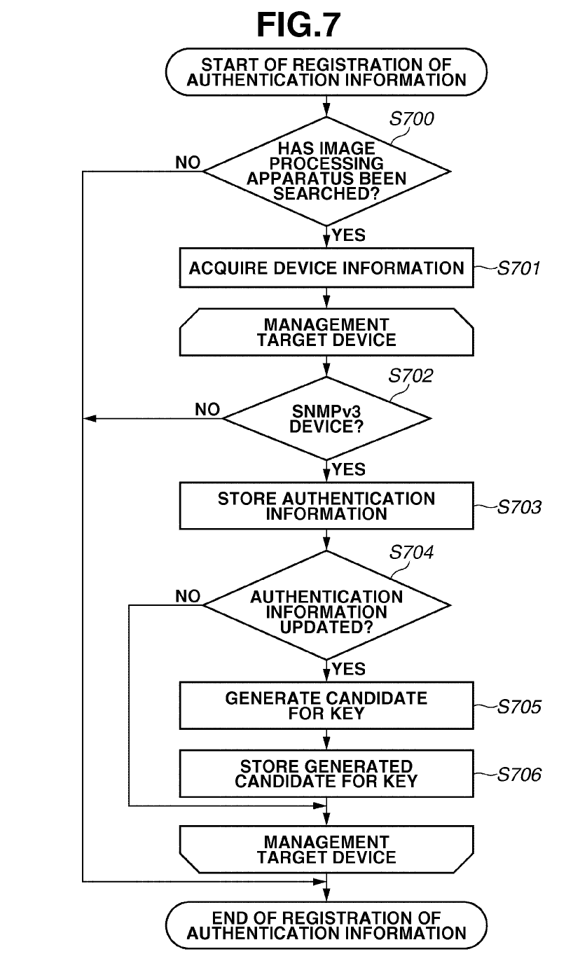

FIG. 7 is a flow chart illustrating an example of a flow of processing according to the present exemplary embodiment for registering the authentication information in the computer 101, which is performed when the update button 608 has been pressed by a user via the screen illustrated in FIG. 6.

The screen illustrated in FIG. 6 is displayed on the client computer 105 as described above. The user operates the mouse and the keyboard of the client computer 105 to enter an updating instruction.

The instruction is sent from the client computer 105 to the computer 101 when the user presses the update button 608. Here, all of the inputs by the user via the screen illustrated in FIG. 6 are sent at this timing.

The management utility 303 of the computer 101 receives the sent inputs and processes the received inputs. After receiving the information, the management utility 303 starts processing illustrated in FIG. 7.

Referring to FIG. 7, in step S700, the management utility 303 determines whether the search for an image processing apparatus has been already performed. If it is determined in step S700 that the search for an image processing apparatus has not been performed yet (NO in step S700), then the processing ends because it is not necessary to store the authentication information.

On the other hand, if it is determined in step S700 that the search for an image processing apparatus has been already performed (YES in step S700), then the processing advances to step S701. In step S701, the management utility 303 acquires information about the image processing apparatus which has been extracted as a result of the search from the DB server service 302.

In step S702, the management utility 303 determines whether the image processing apparatus is an SNMPv3-compliant device.

If it is determined in step S702 that the image processing apparatus is not an SNMPv3-compliant device (NO in step S702), then the processing ends because it is not necessary to store the authentication information. On the other hand, if it is determined in step S702 that the image processing apparatus is an SNMPv3-compliant device (YES in step S702), then the processing advances to step S703.

In step S703, the management utility 303 stores the authentication information entered by the user in the DB. Note that the stored authentication information is used during a communication with the image processing apparatus 102 based on SNMPv3.

In step S704, the management utility 303 determines whether the stored authentication information has been changed from previously stored authentication information. If it is determined in step S704 that the stored authentication information has been changed from previously stored authentication information (YES in step S704), then the processing advances to step S705.

In step S705, the management utility 303 generates a key candidate for the SNMPv3 communication based on the authentication information and information about the image processing apparatus.

In step S706, the management utility 303 stores the generated key candidate in the DB. The management utility 303 performs processing in steps S702 through S706 on all of the SNMPv3-compliant image processing apparatuses 102 that are the target of the management by the computer 101.

On the other hand, if it is determined in step S704 that the stored authentication information has not been changed from previously stored authentication information (NO in step S704), then the management utility 303 ends the processing for registering the authentication information for the image processing apparatus.

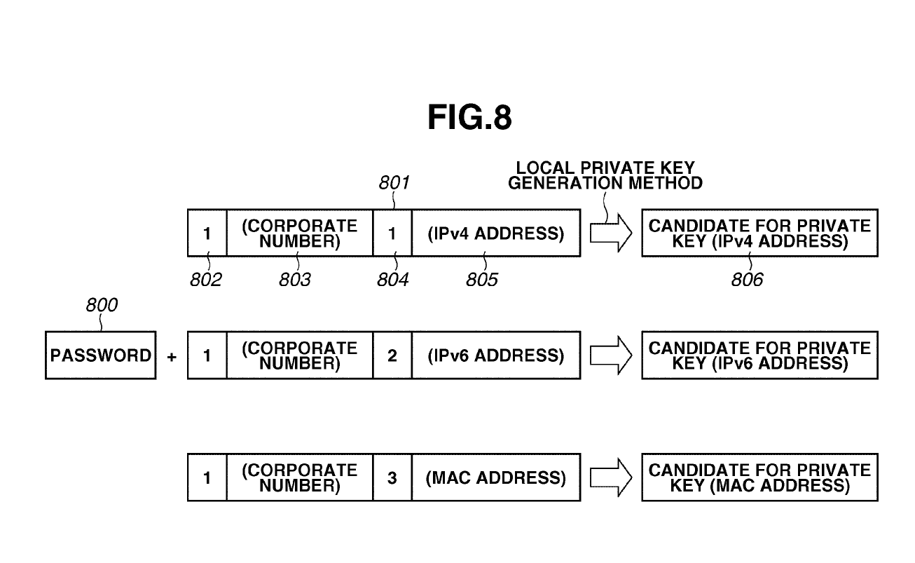

FIG. 8 illustrates a detailed example of a method for generating a key candidate in step S705 (FIG. 7).

Referring to FIG. 8, at first, the management utility 303 generates an SNMP engine ID candidate 801 based on an IP address and a MAC address of the image processing apparatus 102. The SNMP engine ID candidate 801 is generated based on the definition for the SNMP engine ID described in RFC3411.

With respect to the first bit 802, a parameter “1” indicates the SNMPv3 format. With respect to a corporate number 803, the user enters a four-byte corporate number.

A type 804 is single byte data that indicates a type of identification data 805. With respect to the type 804, a parameter “1” indicates an IPv4 address. A parameter “2” indicates an IPv6 address. A parameter “3” indicates a MAC address.

The identification data 805 includes information equivalent to the type 804 among the information about the image processing apparatus. The management utility 303 uses a method for generating a local private key defined by SNMPv3USM to generate a key candidate 806 based on a password 800 and the SNMP engine ID candidate 802.

After the search for the image processing apparatus 102 has been performed and correct authentication information has been stored, the management utility 303 can communicate with the image processing apparatus 102 by the SNMPv3 protocol. In the present exemplary embodiment, processing for changing the setting for the image processing apparatus 102 is described as an example of the SNMPv3 communication.

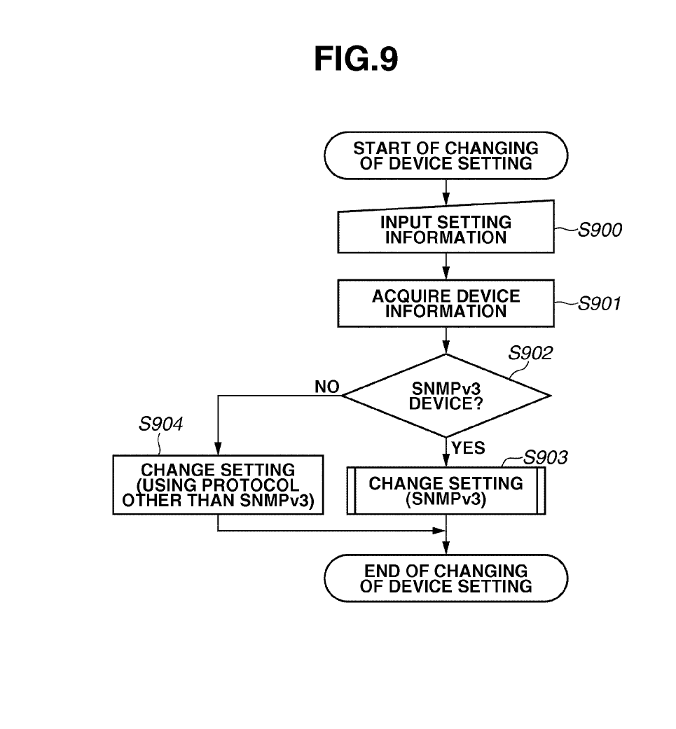

FIG. 9 is a flow chart illustrating an example of processing for changing the setting for the image processing apparatus 102 performed by the management utility 303 according to the present exemplary embodiment.

Referring to FIG. 9, in step S900, the management utility 303 displays a setting item input screen. The user enters a value and information for the setting item to be changed with respect to the image processing apparatus 102 via the setting item input screen.

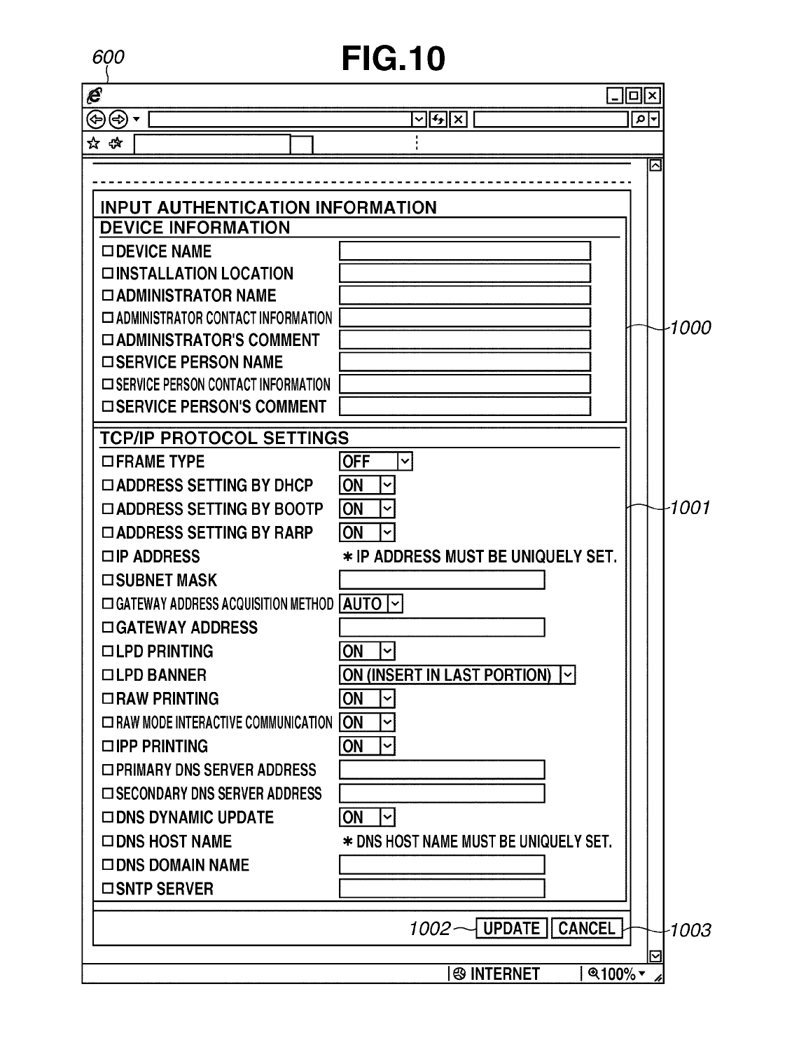

FIG. 10 illustrates an example of a setting item input screen according to an exemplary embodiment of the present invention, which is displayed when the user accesses the management utility 303 of the computer 101 from the client computer 105 using the web browser of the client computer 105. The setting item input screen includes a device information setting item field 1000 and a communication setting item field 1001.

The user selects a check box for each item and sets a value to be newly set in a text box. Then, the user presses an update button 1002 to finalize the changed setting.

More specifically, after the user has pressed the update button 1002, the content of the input by the user in each field illustrated in the setting item input screen in FIG. 10 is sent from the client computer 105 to the computer 101. Immediately after this, processing illustrated in FIG. 9 starts. When the user presses a cancel button 1003, the once-set change is canceled.

The processing illustrated in FIG. 9 is performed by the management utility 303.

The user can enter a device name, an installation location, an administrator company name, administrator contact information, an administrator's comment, a service person name, service person contact information, and a service person's comment via the screen illustrated in FIG. 10. Furthermore, via the screen illustrated in FIG. 10, the user can enter a frame type, a dynamic host configuration protocol (DHCP), a bootstrap protocol (BOOTP), a reverse address resolution protocol (RARP), a subnet mask, a gateway address, whether to perform line printer daemon (LPD) printing, and an address and a name of each of various servers.

Here, an IP address is particularly significant. The IP address can be separately entered via a separate setting screen. Furthermore, the IP address is sent from the management utility 303 to the image processing apparatus 102 when the user issues an instruction for sending the IP address, similarly to the case of other information.

After the entry of the setting items has been completed, in step S901, the management utility 303 acquires information about the image processing apparatus 102 from the DB server service 302. Information acquired here, such as the IP address, is significant information with respect to the communication between the management utility 303 and the image processing apparatus 102.

In step S902, the management utility 303 determines whether the image processing apparatus 102 is an SNMPv3-compliant device. If it is determined in step S902 that the image processing apparatus 102 is not an SNMPv3-compliant device (NO in step S902), the processing advance to step S904. In step S904, the management utility 303 uses a protocol other than SNMPv3 available for the communication to change the setting for the image processing apparatus 102. Then, the processing ends.

On the other hand, if it is determined in step S902 that the image processing apparatus 102 is an SNMPv3-compliant device (YES in step S902), the processing advances to step S903. In step S903, the management utility 303 performs the setting for the image processing apparatus 102.

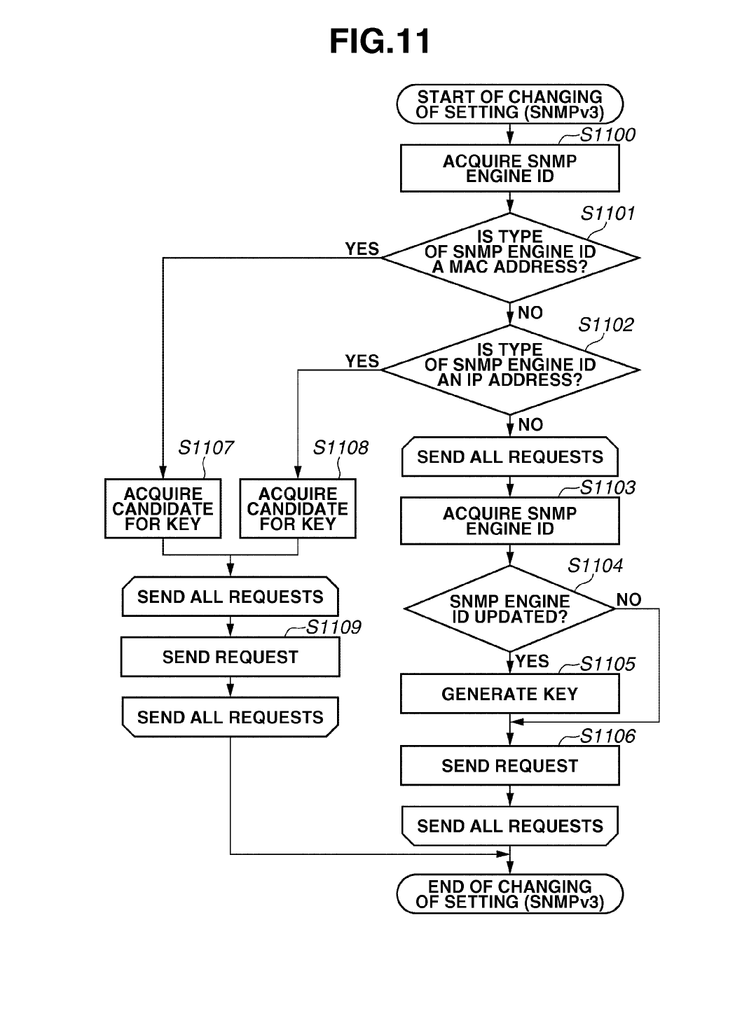

FIG. 11 illustrates a detailed example of a flow of processing for changing the setting in step S903, which is performed based on SNMPv3 according to the present exemplary embodiment.

Referring to FIG. 11, in step S1100, the management utility 303 acquires an SNMP engine ID used for communicating with the SNMP engine of the image processing apparatus 102. In the case of using SNMPv3USM, the SNMP engine ID can be acquired by sending an SNMP request message at a security level of noAuthnoPriv.

Note that in this case, it is necessary to set the length of the descriptions “msgAuthoritativeEngineID” and “msgUserName” at “0” and enter no parameter for the description “varBindList”.

In step S1101, the management utility 303 determines whether the type of the received SNMP engine ID is a MAC address. In step S1102, the management utility 303 determines whether the type of the received SNMP engine ID is an IP address.

If it is determined in step S1101 that the type of the received SNMP engine ID is a MAC address (YES in step S1101), the processing advances to step S1107. In step S1107, the management utility 303 acquires, from the DB server service 302, a key candidate which has been generated based on the MAC address among the key candidates generated in step S705 (FIG. 7).

If it is determined in step S1102 that the type of the received SNMP engine ID is an IP address (YES in step S1102), the processing advances to step S1108. In step S1108, the management utility 303 acquires a key candidate which has been generated based on the IP address from the DB server service 302.

Here, a MAC address and an IP address basically do not change or vary during communication. An IP address may be externally changed, but in such a case, it is necessary to re-search for an IP address because in the case where an IP address is changed during communication, the communication between the management utility 303 corresponding to the IP address before the change and the image processing apparatus 102 is discontinued.

In this regard, in step S1109, the management utility 303 sends all requests for changing the setting for the image processing apparatus 102 by utilizing the received SNMP engine ID and the key candidate.

Accordingly, it is not necessary to acquire an SNMP engine ID or generate a key on every occasion of sending a request. Thus, the time taken for the communication can be shortened.

On the other hand, if it is determined in step S1101 and step S1102 that the type of the received SNMP engine ID is neither a MAC address nor an IP address (NO in steps S1101 and S1102), then the management utility 303 acquires an SNMP engine ID and a key on every occasion of sending a request because the received SNMP engine ID may be changed.

In step S1103, the management utility 303 acquires an SNMP engine ID. In step S1104, the management utility 303 determines whether the engine ID has been updated. If it is determined in step S1104 that the SNMP engine ID has been updated (YES in step S1104), the processing advances to step S1105.

In step S1105, the management utility 303 generates a key using the authentication information and the SNMP engine ID acquired from the DB server service 302. Then, the processing advances to step S1106.

If it is determined in step S1104 that the SNMP engine ID has not been updated (NO in step S1104), the management utility 303 advances to step S1106 without performing any particular processing here. In step S1106, the management utility 303 sends a request using the SNMP engine ID and the key.

Note that in the present exemplary embodiment, each of the MAC address and the IP address is a fixed value uniquely set for the image processing apparatus 102. However, in the case where the type of the SNMP engine ID is a character string or a byte string also, the MAC address and the IP address can be handled and used as device-specific information. Furthermore, it is also useful if the IP address is used as variable information and the MAC address is used as fixed device-specific information.

In a second exemplary embodiment of the present invention, the SNMP engine ID is an IP address. Furthermore, the computer 101 changes the IP address during a communication using SNMPv3.

Note that the system configuration is similar to that in the first exemplary embodiment. Furthermore, the operation of the computer 101 performed when searching for and registering authentication information is similar that in the first exemplary embodiment.

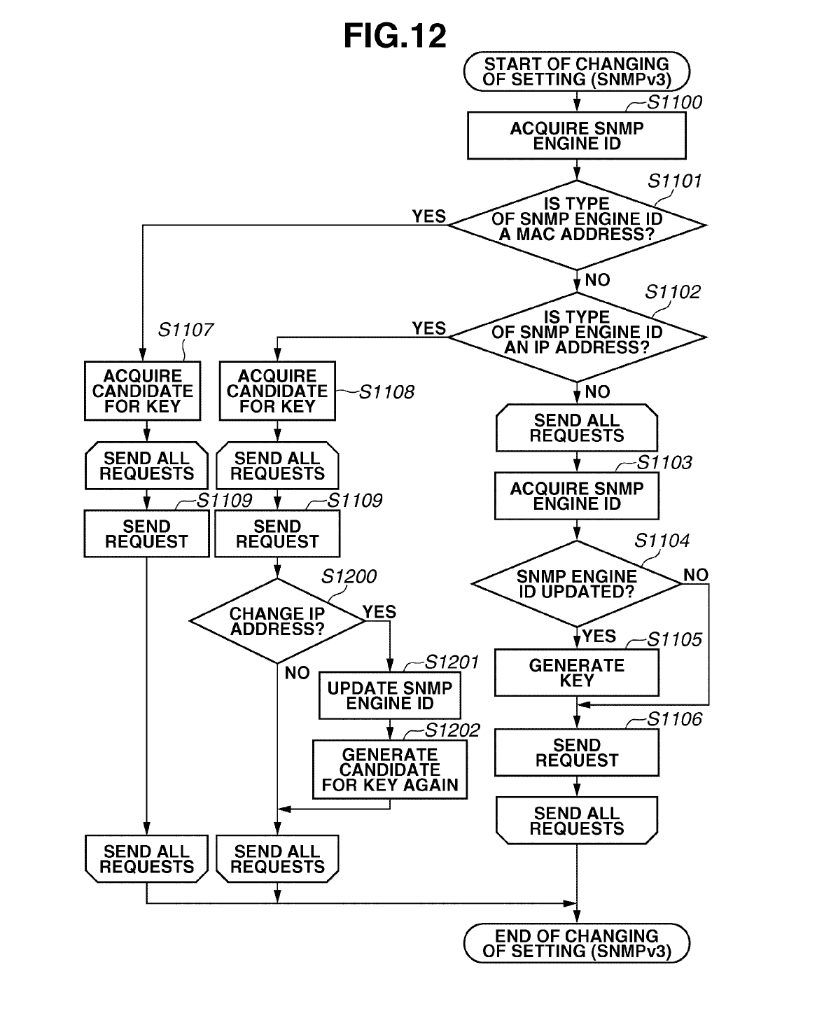

In addition, the operation for changing a setting for the image processing apparatus 102 performed by the computer 101 is similar to that in the first exemplary embodiment up to the processing illustrated in FIG. 9. Accordingly, in the following description, points of difference from the first exemplary embodiment are described. Now, the content of processing in step S903 (FIG. 9) according to the present exemplary embodiment is described with reference to FIG. 12.

FIG. 12 illustrates a detailed example of a flow of processing for changing the setting for the image processing apparatus 102, which is performed by the management utility 303 of the computer 101 by using SNMPv3 protocol according to the present exemplary embodiment. The following processing is performed by the management utility 303. Here, processing in steps S1100 through S1109 is similar to that illustrated in FIG. 11 in the first exemplary embodiment. Accordingly, the description thereof is not repeated here.

Referring to FIG. 12, in step S1200, the management utility 303 performs processing after a request has been sent in the case where the type of the received SNMP engine ID is an IP address. More specifically, the management utility 303 determines whether the sent request includes a description for changing the IP address.

If it is determined in step S1200 that the sent request includes a description for changing the IP address (YES in step S1200), the processing advances to step S1201. In step S1201, the management utility 303 updates the SNMP engine ID using the changed IP address.

In step S1202, the management utility 303 uses the updated SNMP engine ID and the authentication information acquired from the DB server service 302 to regenerate a key candidate.

The management utility 303 uses the changed IP address, the updated the SNMP engine ID, and the key candidate to perform the sending processing at the time of sending a subsequent request and thereafter. Accordingly, the other sending requests can be appropriately sent to the SNMP engine of the image processing apparatus 102 even in the case where the computer 101 has changed the IP address of the image processing apparatus 102.

The processing in step S1103 and subsequent steps are similar to those illustrated in FIG. 11 in the first exemplary embodiment. Accordingly, the description thereof is not repeated here.

It is useful to set a timing for generating a key candidate and substituting an existing key with the newly generated key candidate in step S1202 at a timing after it is ensured that the setting for the IP address has been changed. More specifically, it is useful if a provisional key candidate is generated first and an existing key candidate is erased after it is ensured that the setting for the IP address has been changed.

In the first exemplary embodiment, a key candidate is generated at the time of registering the authentication information after the image processing apparatus 102 has been extracted as a result of the search therefor. Furthermore, the SNMP engine ID is acquired and a key to be used is selected from among the key candidates at the time of an initial SNMPv3 communication. In the present exemplary embodiment, an SNMP engine ID is acquired, the key is generated, and the acquired SNMP engine ID and the generated key are cached previously to the registration of the authentication information.

Note that the system configuration and the operation by the computer 101 for searching for the image processing apparatus 102 are similar to those in the first exemplary embodiment. Accordingly, the description thereof is not repeated here.

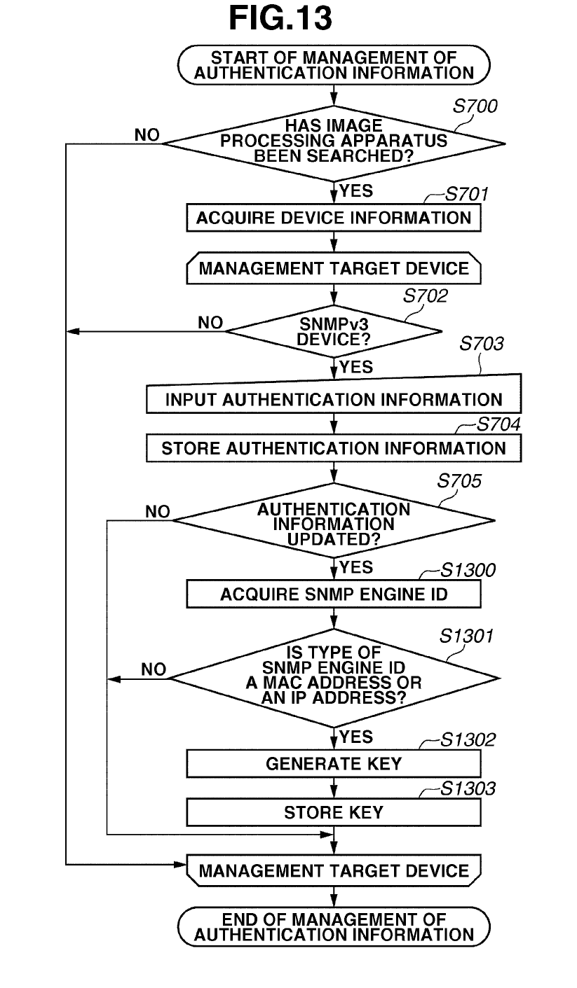

FIG. 13 illustrates an example of a flow of processing for registering authentication information in the computer 101. Note that processing in steps S700 through S705 is similar to that illustrated in FIG. 7 in the first exemplary embodiment. Accordingly, the description thereof is not repeated here.

Referring to FIG. 13, when the authentication information entered by the user is updated, then in step S1300, the management utility 303 acquires an SNMP engine ID for the SNMP engine of the image processing apparatus 102. The method for acquiring the SNMP engine ID is similar to that performed in step S1100 in the first exemplary embodiment.

In step S1301, the management utility 303 determines the type of the acquired SNMP engine ID (a MAC address or an IP address).

If it is determined in step S1301 that the type of the acquired SNMP engine ID is a MAC address or an IP address (YES in step S1301), the processing advances to step S1302.

In step S1302, the management utility 303 generates a key to be utilized in the authentication and encryption during the SNMPv3 communication. The method for generating the key is similar to that illustrated in FIG. 8 in the first exemplary embodiment.

In step S1303, the management utility 303 stores the generated key in the DB server service 302.

The operation of the computer 101 for changing the setting for the image processing apparatus 102 is similar to that in the first exemplary embodiment. Moreover, the processing performed up to the processing for establishing the SNMPv3 communication is similar to that in the first exemplary embodiment.

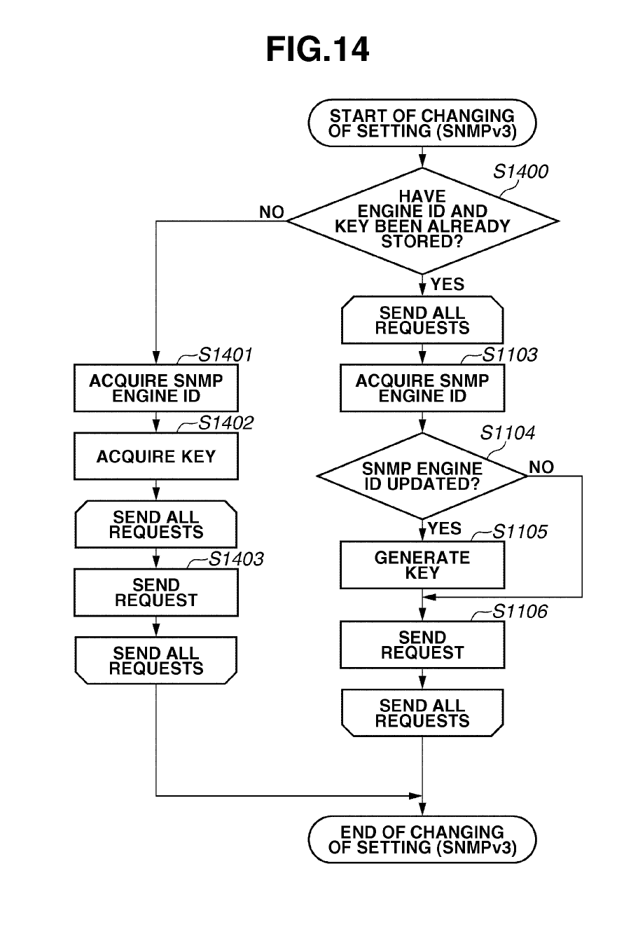

In the following description, points of difference from the first exemplary embodiment are primarily described. The content of processing in step S903 in FIG. 9 according to the present exemplary embodiment is now described below with reference to FIG. 14.

FIG. 14 illustrates an example of processing for changing the setting for the image processing apparatus 102 performed by the computer 101 using SNMPv3 according to the present exemplary embodiment.

Referring to FIG. 14, in step S1400, the management utility 303 determines whether the SNMP engine ID and the key have been already stored in the DB server service 302 at the time of registration of the authentication information.

If it is determined that the SNMP engine ID and the key have been already stored in the DB server service 302 at the time of registration of the authentication information (YES in step S1400), the processing advances to step S1103.

In steps S1103 through 1106, the management utility 303 acquires an SNMP engine ID and generates a key if the SNMP engine ID has been updated. The management utility 303 sends a request based on SNMPv3 using the SNMP engine ID and the key. The above-described processing is repeated for all of the requests to be sent.

On the other hand, if it is determined in step S1400 that the SNMP engine ID and the key have not been stored in the DB server service 302 yet at the time of registration of the authentication information (NO in step S1400), the processing advances to step S1401.

In step S1401, the management utility 303 acquires an SNMP engine ID from the DB server service 302. Instep S1402, the management utility 303 acquires a key from the DB server service 302.

In step S1403, the management utility 303 sends all of the requests based on the authentication processing and the encrypted communication by SNMPv3 using the acquired SNMP engine ID and key.

In the first exemplary embodiment, the computer 101 searches for the image processing apparatus 102 before registering the authentication information and performing the processing for changing the setting for the image processing apparatus 102. In a third exemplary embodiment of the present invention, the key candidate is updated in the case where the IP address is changed after searching for the image processing apparatus 102 and generating a key candidate at the time of registering the authentication information.

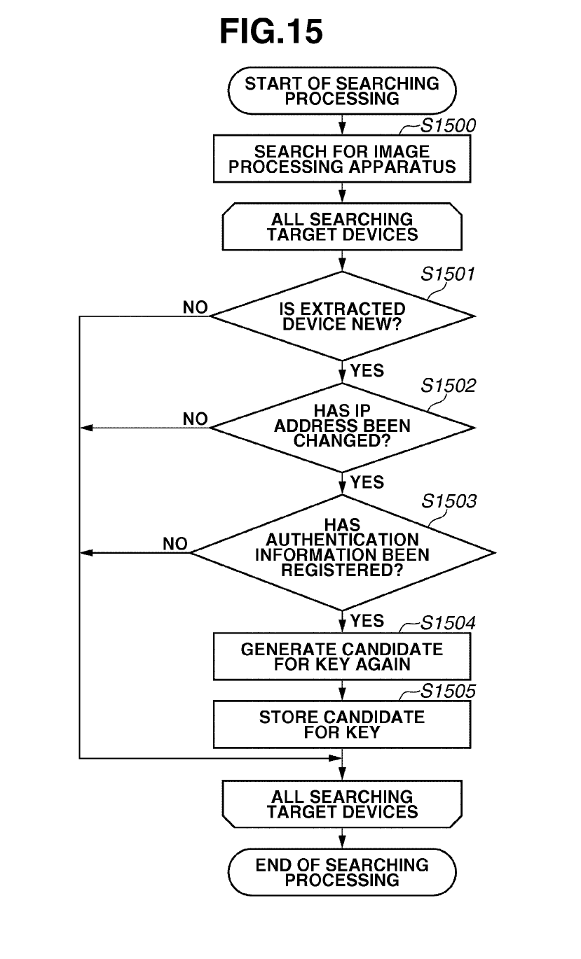

Note that the system configuration and the operation performed by the computer 101 for registering the authentication information and changing the setting for the image processing apparatus 102 are similar to those in the first exemplary embodiment. Accordingly, the description thereof is not repeated here. Now, the operation of the computer 101 performed during the search for the image processing apparatus is described below with reference to FIG. 15.

Referring to FIG. 15, in step S1500, the management utility 303 searches for the image processing apparatus 102 on the network. The method for searching for the image processing apparatus 102 is similar to those in the first exemplary embodiment.

In step S1501, the management utility 303 determines whether the image processing apparatus 102 extracted as a result of the search is a newly extracted device. If it is determined in step S1501 that the image processing apparatus 102 extracted as a result of the search is a newly extracted device (YES in step S1501), the processing advances to step S1502.

In step S1502, the management utility 303 determines whether the IP address has been changed from that in a previous search result. If it is determined in step S1502 that the IP address has not been changed from that in the previous search result (NO in step S1502), then the management utility 303 ends the processing because it is not necessary to regenerate a key candidate.

If it is determined in step S1502 that the IP address has been changed from that in a previous search result (YES in step S1502), the processing advances to step S1503. In step S1503, the management utility 303 determines whether the authentication information has been registered.

If it is determined in step S1503 that the authentication information has been registered (YES in step S1503), the processing advances to step S1504. In step S1504, the management utility 303 regenerates a key candidate. In step S1505, the management utility 303 stores the regenerated key in the DB server service 302.

By performing the processing, a key candidate can be automatically regenerated when the image processing apparatus 102 is searched again even in the case where the IP address is changed after the image processing apparatus 102 has been extracted as a result of the search therefor and a key candidate is generated at the time of registering the authentication information. Here, the above-described processing is performed by the management utility 303.

A fourth exemplary embodiment of the present invention is described below. In the first exemplary embodiment, as described above, the SNMP engine ID and the key candidate, which has been previously generated, are cached and used in the case where the type of the acquired SNMP engine ID is a MAC address or an IP address. In the present exemplary embodiment, a vendor-definable area of the ID type is utilized to increase the speed of the communication.

In the SNMP engine ID 801 illustrated in FIG. 8, the type 804 is defined by RFC3411. According to RFC3411, type values from 128 to 255 can be vendor-definable.

In this regard, in the present exemplary embodiment, the vendor-defined area based on the type of the SNMP engine ID utilized by the image processing apparatus 102 and the computer 101 is divided into a fixed value area and a variable value area.

Thus, during the communication between the computer 101 and the image processing apparatus 102 based on the SNMPv3 protocol, the image processing apparatus 102 notifies the computer 101 of whether it is necessary to acquire an SNMP engine ID at every occasion of sending a request.

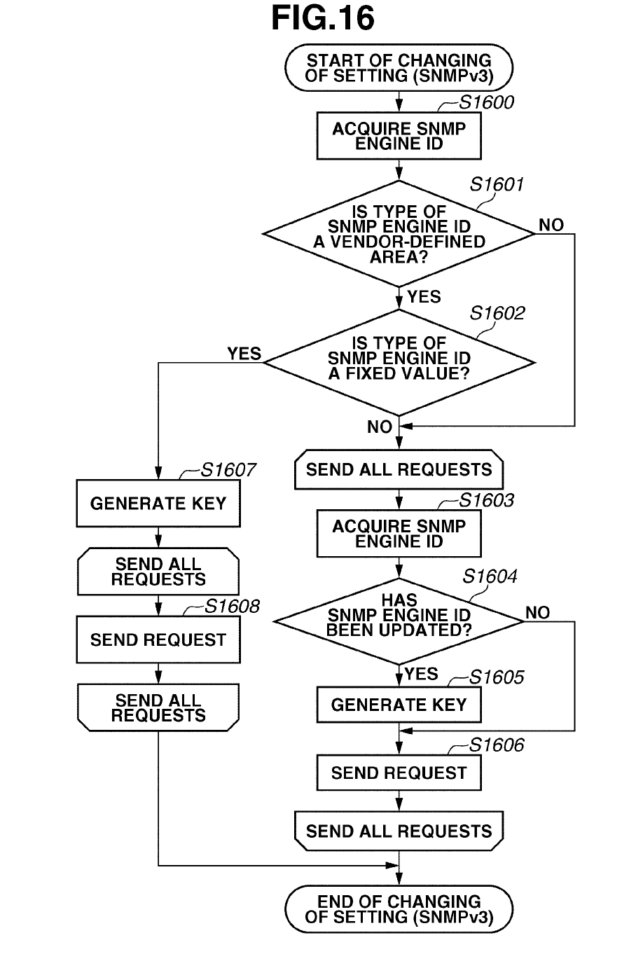

Now, processing for changing the setting for the image processing apparatus 102 according to the present exemplary embodiment, which is performed by the computer 101 using SNMPv3, is described below with reference to FIG. 16.

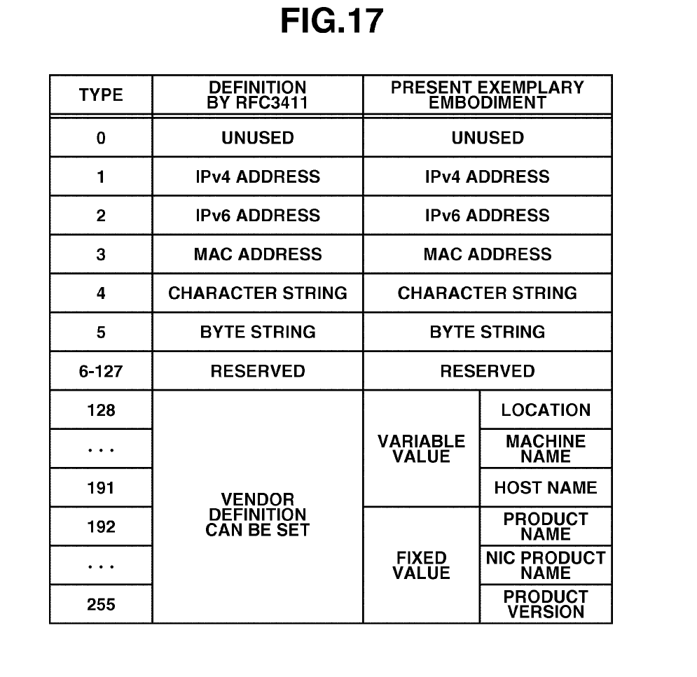

Note here that it is supposed that the image processing apparatus 102 and the computer 101 utilize the setting for the SNMP engine ID (FIG. 17) and that the image processing apparatus 102 has already been extracted as a result of the search and the authentication information has been already registered.

Referring to FIG. 16, the management utility 303 acquires an SNMP engine ID in step S1600. The method for acquiring the SNMP engine ID is similar to that in step S1100 in the first exemplary embodiment.

In step S1601, the management utility 303 determines whether the type of the acquired SNMP engine ID is a vendor-defined area.

If it is determined in step S1601 that the type of the acquired SNMP engine ID is not a vendor-defined area (NO in step S1601), the processing advances to step S1603. In steps S1603 through S1606, the management utility 303 acquires an SNMP engine ID on every occasion of sending a request.

In the case where the engine ID has been updated, the management utility 303 generates a key. The management utility 303 sends a request based on SNMPv3 using the SNMP engine ID and the key.

On the other hand, if it is determined in step S1601 that the type of the acquired SNMP engine ID is a vendor-defined area (YES in step S1601), the processing advances to step S1602. In step S1602, the management utility 303 determines whether the type of the engine ID is an area indicating a fixed value.

If it is determined in step S1602 that the types of the engine ID is an area indicating a fixed value (YES in step S1602), the processing advances to step S1607.

In step S1607, the management utility 303 generates a key. Then, in step S1608, the management utility 303 sends a request using the generated key and the SNMP engine ID.

On the other hand, if it is determined in step S1602 that the type of the SNMP engine ID is an area indicating a variable value (NO in step S1602), the processing advances to step S1603.

In steps S1603 through S1606, the management utility 303 acquires an SNMP engine ID every time a request is sent, generates a key if the SNMP engine ID has been updated, and sends a request.

As described above, the management utility 303 determines whether it is necessary to acquire an SNMP engine ID for every communication by utilizing the vendor-defined area of the type field for the SNMP engine ID.

Accordingly, the number of times of performing the SNMP engine ID acquisition operations and key generation operations can be reduced. Thus, the time taken for the communication can be shortened.

More specifically, in the present exemplary embodiment, it is previously designated in which area the SNMP engine ID is stored as a fixed value and in which area the variable value is stored. Thus, it is determined whether the SNMP engine ID is a fixed value based on from which area the SNMP engine ID is acquired.

As described above, according to the present exemplary embodiment, the computer 101 can be implemented which can communicate with peripheral devices by using a version of SNMP of a version that requires a key during communication.

In addition, as described above, the management utility 303 can be implemented which can acquire device-specific information from each of image processing apparatuses 102 through 104. Here, a MAC address or an IP address can be used as the SNMP engine ID.

In the present exemplary embodiment, before the communication based on SNMPV3, information illustrated in FIG. 8, which is an example of key information, is generated based on the device-specific information. The management utility 303 acquires an SNMP engine ID for identifying the image processing apparatus 102.

Furthermore, the management utility 303 determines whether the SNMP engine ID corresponds to the device-specific information. For example, the management utility 303 determines whether the SNMP engine ID is none other than an IP address or a MAC address. Otherwise, the management utility 303 determines whether the SNMP engine ID is an ID obtained by performing predetermined encoding processing on an IP address or a MAC address.

Furthermore, if it is determined by the management utility 303 that the SNMP engine ID corresponds to the device-specific information, then the management utility 303 stores the SNMP engine ID. The management utility 303 performs a communication based on SNMP using the generated key information. The processing is performed within the computer 101, which is an example of a network management apparatus.

If it is determined by the management utility 303 that the SNMP engine ID corresponds to the device-specific information and a request for changing the device-specific information is sent to the peripheral device, then the management utility 303 updates the stored key candidate.

The management utility 303 determines whether the acquired SNMP engine ID is a variable value or a fixed value.

It is also useful that if it is determined that the acquired SNMP engine ID is a fixed value, then the management utility 303 holds the SNMP engine ID until the communication session is completed, generates key information using the stored SNMP engine ID, and performs a communication based on SNMP by utilizing the generated key information.

The management utility 303 receives an instruction for updating the setting information set for the image processing apparatus 102.

The management utility 303 determines whether the received instruction is an instruction for changing the IP address.

In the case where the SNMP engine ID is an IP address and if it is determined by the management utility 303 that the received instruction is an instruction for changing the IP address, then the management utility 303 performs the following processing. That is, the management utility 303 performs processing for setting an IP address based on SNMP by using the key candidate that has been generated with the IP address that has been used before the change.

Furthermore, the management utility 303 regenerates a key candidate using the changed IP address.

On the other hand, if it is determined by the management utility 303 that the received instruction does not instruct changing of the IP address, then the management utility 303 performs the following processing. That is, the management utility 303 performs processing for setting the IP address by using SNMP based on the key candidate that has not been changed so as not to regenerate a key candidate.

In addition, the functions according to the above-described exemplary embodiments illustrated in FIGS. 7, 9, 11, 12, 13, 14, 15, and 16 can be implemented by the computer 101 using a program that is externally installed. In this case, the present invention is applied to the case where a group of information including a program is supplied to a host computer from a storage medium, such as a compact disc-read only memory (CD-ROM), a flash memory, or a floppy disk (FD), or from an external storage medium via a network.

Furthermore, the present invention can also be achieved by providing a system or a device with a storage medium (or a recording medium) which stores program code of software implementing the functions of the embodiments or by downloading the same from an external server (not illustrated) and by reading and executing the program code stored in the storage medium with a computer of the system or the device (a CPU or an micro processing unit (MPU)).

In this case, the program code itself, which is read from the storage medium, implements the functions of the embodiments mentioned above, and accordingly, the storage medium storing the program code constitutes the present invention.

As the storage medium for supplying such program code, a floppy disk, a hard disk, an optical disk, a magneto-optical disk, a digital versatile disc (DVD), a DVD-recordable (DVD-R), a DVD-rewritable (DVD-RW), a CD-ROM, a CD-R, a CD-rewritable (CD-RW), a magnetic tape, a nonvolatile memory card, a ROM, and an electrically erasable programmable ROM (EEPROM), for example, can be used.

In addition, the functions according to the embodiments described above can be implemented not only by executing the program code read by the computer, but also implemented by the processing in which an operating system (OS) or the like carries out a part of or the whole of the actual processing based on an instruction given by the program code.

Further, in another aspect of the embodiment of the present invention, after the program code read from the storage medium is written in a memory provided in a function expansion board inserted in a computer or a function expansion unit connected to the computer, a CPU and the like provided in the function expansion board or the function expansion unit carries out a part of or the whole of the processing to implement the functions of the embodiments described above.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2007-281835 filed Oct. 30, 2007, which is hereby incorporated by reference herein in its entirety.

What is claimed is:

1. A network management apparatus configured to communicate with a peripheral device using a version of Simple Network Management Protocol (SNMP) that requires key information during communication, the network management apparatus comprising:
an acquisition unit configured to acquire device-specific information from the peripheral device;
a generating unit configured to generate a plurality of key information candidates using the device-specific information before performing a communication based on SNMP;
an identification unit configured to acquire an SNMP engine identification (ID) for the peripheral device;
a first determination unit configured to determine whether the SNMP engine ID corresponds to the device-specific information; and
a communication unit configured, if it is determined by the first determination unit that the SNMP engine ID corresponds to the device-specific information, to store the SNMP engine ID and to perform a communication based on SNMP using key information corresponding to the device-specific information and selected from among the plurality of key information candidates.

2. The network management apparatus according to claim 1, wherein the device-specific information includes a Media Access Control (MAC) address or an Internet Protocol (IP) address.

3. The network management apparatus according to claim 1, further comprising an updating unit configured to update the stored SNMP engine ID if it is determined by the first determination unit that the SNMP engine ID corresponds to the device-specific information and a request for changing the device-specific information is sent to the peripheral device.

4. The network management apparatus according to claim 1, further comprising:
a second determination unit configured to determine whether the SNMP engine ID is a variable value or a fixed value; and
a storage unit configured, if it is determined by the second determination that the SNMP engine ID is a fixed value, to store the SNMP engine ID until a communication session is completed, to generate key information using the SNMP engine ID, and to perform a communication based on SNMP using the key information.

5. The network management apparatus according to claim 1, further comprising:
a receiving unit configured to receive an instruction for updating setting information set for the peripheral device;
a second determination unit configured to determine whether the received instruction is for instructing changing of an Internet Protocol (IP) address; and
a processing unit configured, if, when the SNMP engine ID is an IP address, if it is determined by the second determination that the received instruction is for instructing changing of an IP address, to perform processing for setting the IP address based on SNMP using a key information candidate generated using the IP address before being changed and to regenerate a key information candidate using a changed IP address, and, if it is determined by the second determination that the received instruction is not for instructing changing of an IP address, to perform processing for setting an IP address based on SNMP using a key information candidate before being changed without regenerating a key information candidate.

6. The network management apparatus according to claim 1, wherein the determination unit is configured to determine whether the SNMP engine ID is a variable value or a fixed value based on a vendor-defined area.

7. A method for a network management apparatus configured to communicate with a peripheral device using a version of Simple Network Management Protocol (SNMP) that requires key information during communication, the method comprising:
acquiring device-specific information from the peripheral device;
generating a plurality of private key information candidates using the device-specific information before performing a communication based on SNMP;
acquiring an SNMP engine identification (ID) for the peripheral device;
determining whether the SNMP engine ID corresponds to the device-specific information; and
if it is determined that the SNMP engine ID corresponds to the device-specific information, storing the SNMP engine ID and performing a communication based on SNMP using key information corresponding to the device-specific information and selected from among the plurality of key information candidates.

8. The method according to claim 7, wherein the device-specific information includes a Media Access Control (MAC) address or an Internet Protocol (IP) address.

9. The method according to claim 7, further comprising updating the stored SNMP engine ID if it is determined that the SNMP engine ID corresponds to the device-specific information and a request for changing the device-specific information is sent to the peripheral device.

10. The method according to claim 7, further comprising:
determining whether the acquired SNMP engine ID is a variable value or a fixed value; and
if it is determined that the SNMP engine ID is a fixed value, storing the SNMP engine ID until a communication session is completed, generating key information using the SNMP engine ID, and performing a communication based on SNMP using the key information.

11. The method according to claim 7, further comprising:
receiving an instruction for updating setting information set for the peripheral device;
determining whether the received instruction is for instructing changing of an Internet Protocol (IP) address; and
if, when the SNMP engine ID is an IP address, if it is determined that the received instruction is for instructing changing of an IP address, performing processing for setting the IP address based on SNMP using a key information candidate generated using the IP address before being changed and regenerating a key information candidate using a changed IP address, and, if it is determined that the received instruction is not for instructing changing of an IP address, performing processing for setting an IP address based on SNMP using a key information candidate before being changed without regenerating a key information candidate.

12. The method according to claim 7, further comprising determining whether the SNMP engine ID is a variable value or a fixed value based on a vendor-defined area.

13. A computer-readable storage medium storing instructions which, when executed by a network management apparatus configured to communicate with a peripheral device using a version of Simple Network Management Protocol (SNMP) that requires key information during communication, causes the network management apparatus to perform operations comprising:
acquiring device-specific information from the peripheral device;
generating a plurality of private key information candidates using the device-specific information before performing a communication based on SNMP;
acquiring an SNMP engine identification (ID) for the peripheral device;
determining whether the SNMP engine ID corresponds to the device-specific information; and
if it is determined that the SNMP engine ID corresponds to the device-specific information, storing the SNMP engine ID and performing a communication based on SNMP using key information corresponding to the device-specific information and selected from among the plurality of key information candidates.
